(19) United States
(12) Patent Application Publication
(10) Pub. No.: US 2023/0070474 A1
(43) Pub. Date: Mar. 9, 2023

(54) INTERMEDIATE STORAGE DOSING UNIT AND SYSTEM AND METHOD FOR TAKING SAMPLES OF A FLUID

(71) Applicant: Deutsches GeoForschungsZentrum-GFZ, Potsdam (DE)

(72) Inventors: Christoff Andermann, Potsdam (DE); Torsten Queisser, Potsdam (DE); Markus Reich, Potsdam (DE)

(73) Assignee: Deutsches GeoForschungsZentrum-GFZ, Potsdam (DE)

(21) Appl. No.: 17/902,188

(22) Filed: Sep. 2, 2022

(30) Foreign Application Priority Data
Sep. 6, 2021 (DE) 102021122997.9

(51) Int. Cl. G01N 35/10; B01L 3/00

(52) U.S. Cl. CPC G01N 35/1016; B01L 3/502; B01L 2200/026; B01L 2400/0622; B01L 2300/0681; G01N 2035/1025

(57) ABSTRACT

An intermediate storage dosing unit for taking samples of a fluid. The intermediate storage dosing unit includes a container with an inlet and a two-way outlet. The two-way outlet has a riser as a first outlet and a drain as a second outlet. A system and a method for taking samples of a fluid. In particular, the system includes a sample acquisition unit and at least one sample vessel, the sample acquisition unit is configured to provide a fluid and the at least one sample vessel is configured to receive and store a fluid. A fluid transfer is also possible between the sample acquisition unit and the at least one sample vessel. The intermediate storage dosing unit of the type mentioned is connected between the sample acquisition unit and the at least one sample vessel.

The invention relates to an intermediate storage dosing unit for taking samples of a fluid. The intermediate storage dosing unit comprises a container with an inlet and a two-way outlet. The two-way outlet has a riser as a first outlet and a drain as a second outlet. Furthermore, the invention relates to a system and a method for taking samples of a fluid, preferably water. In particular, the system comprises a sample acquisition unit and at least one sample vessel, wherein the sample, acquisition unit is configured to provide a fluid and the at least one sample, vessel is configured to receive and store a fluid. A fluid transfer is also possible between the sample acquisition unit and the at least one sample vessel. The intermediate storage dosing unit of the type mentioned is connected between the sample, acquisition unit and the at least one sample vessel.

### BACKGROUND AND PRIOR ART

The taking of samples (or random samples) according to defined methods is known from the prior art. Sampling serves for making reliable statements about the quality, nature or composition of a specific material. The aim is to generate a sample that is as representative and reproducible as possible and that corresponds as closely as possible to the actual, real state of matters at the time of sampling.

Sampling is used in particular in connection with water or waste water. Sampling is often required by law. In particular, it helps to protect surface water, to monitor wastewater treatment processes or to identify affluents into the sewage system.

Devices are also known which enable automatic sampling. Such devices are used, inter alia, for industrial and municipal sewage treatment plants or water authorities. For example, U.S. Pat. No. 5,433,120 A discloses a sampler with a T-valve provided with a motor control. However, the devices known from the prior art have the disadvantage that a sample cannot be taken cumulatively over time and subjected to filtering at the same time. In addition, the devices lack a “smart” sampling method that makes it possible to control different sample vessels individually and to fill them automatically, wherein the storage is atmospherically sealed.

### OBJECT OF THE INVENTION

The object of the invention is therefore to eliminate the disadvantages of the prior art and to provide a device and a system as well as a method for automated sampling, wherein a sample can be taken cumulatively over time and at the same time be subject to filtering and, in addition, a large number of individual sample vessels can be filled individually.

### SUMMARY OF THE INVENTION

The object is attained according to the invention by the features of the independent claims. Advantageous embodiments of the invention are described in the dependent claims. In a preferred embodiment, the invention relates to an intermediate storage dosing unit for taking samples of a fluid, comprising a container with an inlet and a two-way outlet, wherein the two-way outlet comprises
a riser as a first outlet and
a drain as a second outlet.

The use of the proposed intermediate storage dosing unit for taking samples of a fluid is neither known from the prior art nor is it suggested to a person skilled in the art in this context. When taking a sample, the aim is generally to preserve the actual state of a fluid reservoir and then to analyze it. It has therefore not previously appeared expedient to subject a sample to pre-processing or filtering before storing it.

It has been shown that an intermediate storage dosing unit increases the quality of the samples and that, in particular, improved analyzes can be generated. The intermediate storage dosing unit advantageously enables a fluid to be collected and discharged in a controlled manner, preventing the contamination of a sample by floating matter and/or Sediment or similar prevented and all geo-chemical properties of the fluid and/or of the sample are retained. The intermediate storage dosing unit thus enables sampling which is cumulatively integrated over time, improved in quality and that can be uniquely assigned in terms of time.

In the case of heavy rain events, for example, larger volumes can be collected first and then a small sample can be taken (automatically) so that a specific time period during a (rain) event is included for the sampling. In addition, with the inlet, which is preferably provided with an inlet valve, a further inflow can be prevented, so that an accumulation occurs, which can also be directly admitted and sampled after the previous sampling and emptying of the collection container.

According to the invention, the fluid is particularly preferably a liquid. It can preferably be all liquids as well as suspensions. Furthermore, floating matter, suspended matter and/or particles can be included in a liquid. The fluid can preferably also be in the form of a gas. The intermediate storage dosing unit is preferably to be understood as a technical unit or assembly or also a device which can take up a fluid via an inlet, store it (temporarily) in a container and secrete a fluid via an outlet. On the way between inlet and outlet, the fluid is preferably filtered. Both the inlet and the outlet are preferably compatible for a wide variety of conduit systems, as a result of which the use of the intermediate storage dosing unit can advantageously be integrated into conventional systems for taking samples of a fluid, without major structural modifications being necessary. The intermediate storage dosing unit enables a fluid to be filtered without the use of external energy. The inlet and the outlet are preferably designed in such a way that a fluid can be conducted from the inlet to the outlet solely due to gravity (in the case of liquids) or buoyancy (in the case of gases). The fluid can be separated from undesired components within the intermediate storage dosing unit or it can also just be collected.

A two-way outlet is preferably to be understood as an outlet which has two outlets which are alternatively positioned to one another. These outlets can preferably be opened and/or closed individually. It goes without saying that the suspended substances in the fluid contained in the intermediate storage dosing unit are not completely and evenly mixed within the container, as a result of which the fluid has different properties in certain regions. Because the outlets which are alternatively positioned to one another are preferably placed at different points or positions within the intermediate storage dosing unit or the container, different regions or partial volumes of a fluid reservoir can be separated from one another. The two-way outlet can accordingly act as a filter unit. The two-way outlet according to the invention therefore particularly advantageously enables, in addition to the discharging as such, a separation of the fluid, preferably a liquid, of floating matter, suspended matter and/or particles.

In this regard, the riser according to the invention has an essential task. The riser is preferably placed in the container of the intermediate storage dosing unit in such a way that an outlet opening or tube opening protrudes as far as possible into the container and is spaced from a bottom or edge of the container. As a result, a partial volume of the fluid contained in the container can advantageously be left out, which is at a distance from an edge of the container and is not influenced by it. In a liquid, for example, sediments, floating matter and suspended matter and/or particles are often deposited in the edge region, for example, as a sediment. By removing the liquid from a region of the container remote from the edge, advantageously the discharged fluid does not contain these sediments, floating matter, suspended matter and/or particles. The sediments, floating matter, suspended matter and/or particles are accordingly still retained within the intermediate storage dosing unit. The riser is preferably to be understood as a first outlet. The riser is aligned within the container in such a way that the fluid, preferably a liquid, can be introduced into the tube opening by gravity. In principle, this preferably means that no pump or other means are strictly necessary to support the fluid, preferably a liquid, in flowing through the riser. In the sense of the invention, a riser enables, among other things, the removal of a sample from a water column within the intermediate storage dosing unit.

In order to also remove or examine coarse particles (e.g. clumps of particles) and the contamination remaining in the container (sediments, floating matter, suspended matter and/or particles or bottom accretions) the drain, also known as the second outlet, is provided. The drain preferably has a significantly larger outlet opening in comparison to the riser, which opening is arranged in an edge or bottom region of the container of the intermediate storage dosing unit. It is understood that particles, floating matter, sediments settle on a bottom or edge of the container due to gravity and create a sediment, which sediment can also deposit on the plug of the drain. By opening the plug, any fluid remaining in the container of the intermediate storage dosing unit can be disposed of in a drain conduit, together with the dirt. Particularly preferably, a sample can be taken through the preferred riser, while excess sample water is disposed of gravitationally via the drain after the filling process.

The container contained in the proposed intermediate storage dosing unit preferably tapers conically at least in portions in the direction of the two-way outlet. The container is preferably to be divided into two portions, namely an upper cylindrical portion and a lower portion that tapers conically in the direction of an outlet. Due to the tapering, the container acts like a funnel, which in particular can ensure that the entire content of the container can be emptied. The terms “up” and “down” are to be understood in relation to a bottom, with an upper portion of the container being at a greater distance from a bottom than a lower portion.

In a further preferred embodiment, the intermediate storage dosing unit is characterized in that the drain of the two-way outlet and/or the inlet can be closed by a respective valve, preferably a ball valve. By closing the drain and/or of the inlet, the quantity of a fluid within the intermediate storage dosing unit can be controlled. For example, the flow rate of the fluid can be controlled. The fluid can also advantageously be collected cumulatively over a period of time, preferably by having the inlet open and the drain closed.

The valve is particularly preferably configured as a ball valve. Ball valves generally have small dimensions and can ensure adequate tightness even at high pressure. In addition, rapid actuation is also achieved. The ball valve can preferably be opened and closed under motor control. In addition, ball valves have a large passage cross section and advantageously do not require any lubricants, which would lead to contamination of the sample. It is also advantageous that a ball valve has only a very small dead volume, since this is located directly in the volume flow. This is important for high sample quality so that sample carryover does not occur. The full passage cross-section of the conduit is preferably cleared when it is opened, which is an important prerequisite for gravitational filling, so that the liquid column can move by itself from the collecting funnel (preferably sample acquisition unit) to the collecting vessel (preferably container).

The ball valve is preferably selected from the group:
one-piece ball valve with reduced passage and internal thread, where “one-piece” refers to the body of the ball valve
2-piece ball valve with full passage and internal threads (I/I), where “2-piece” refers to the body of the ball valve, as well as analogously in the following embodiments
2-piece ball valve with full passage and internal/external threads (I/A)
3-piece ball valve with full passage, internal thread and ISO-TOP (actuator)
3-way ball valve with full passage, T or L passage, internal thread and ISO-TOP 5211 for actuator
mini ball valve I/I or I/A
one-piece compact ball valve
2-piece flanged ball valve
3-piece ball valve with cutting ring or press connection
ball outlet valve (KFE tap)

The ball valve is particularly preferred a 2/2-way valve, which includes two ports and two positions with a through hole.

In a further preferred embodiment, the intermediate storage dosing unit is characterized in that the intermediate storage dosing unit has a filter unit which comprises a filter support and a filter substrate;
wherein the filter support is designed as a grid insert with a wall and a mounting element;
wherein a channel acting as an overflow and/or as a vent for the container is introduced in the wall and in the mounting element;
wherein the filter substrate rests on the grid insert, and preferably comprises a fleece.

In addition to the aforementioned separation of the fluid from sediments, floating matter, suspended matter and/or particles or sediment using the two-way outlet, the filter unit is used for further filtering of the sample or the fluid. This means that the samples are of better quality and can therefore also be subjected to better analysis. Aspects such as the occurrence of contamination of samples can be minimized by the intermediate storage dosing unit according to the invention.

In addition, the filtering of the fluid does not result in the falsification of a sample, but only serves to simplify the analysis of a sample that has been taken. Rather, the filter unit is preferably set up so that the fluid is filtered in a way that the geo-chemical properties of the fluid and/or of the sample are retained. It is also advantageous that the proposed filter unit, in addition to its function as a filter, also enables the container to be vented. Likewise, the channel contained in the filter unit can act as an overflow and prevent the fluid within the container from exceeding a certain volume. Among other things, this protects against damage to the electronics in the device housing.

The filter support is also preferably a support element and/or supporting element which can support or hold or accommodate a filter, in particular a filter substrate. The filter support preferably holds the filter substrate in such a way that a fluid penetrates the filter substrate on the way from an inlet to an outlet. The filter substrate is particularly preferably arranged in such a way that there is sufficient free space upstream and downstream of the substrate for the fluid to be able to pass through the substrate without clogging. According to the invention, the wall is designed in the form of a ring and preferably has a shoulder at its upper edge, which is referred to as a mounting element. The ring-shaped wall is preferably placed in the interior of the container of the intermediate storage dosing unit and placed on a container edge via the mounting element. The ring-shaped wall also preferably has an outside diameter which is essentially as large as the inside diameter of the container in a cylindrical portion.

Terms such as ‘substantially’ ‘approximately’, ‘about’, ‘ca.’ etc. preferably describe a tolerance range of less than ±40%, preferably less than ±20%, particularly preferably less than ±10%, even more preferably less than ±5%, and particularly less than ±1%. The term ‘similarly’ preferably describes sizes that are “approximately the same”. ‘Partially’ describes preferably at least 5%, particularly preferably at least 10%, and particularly at least 20%, in some cases at least 40%.

Preferably, the grid insert is included in the filter unit, and can serve, for example, as a filter support. The grid insert is designed in such a way that it can accommodate or hold the filter substrate, the fluid advantageously being able to drain through the free space of the grid and wherein the fluid does not accumulate. The grid insert is preferably circular in shape, with the grid insert preferably being used within the ring-shaped wall. The wall preferably has a clamping element in which the grid insert can be clamped in a fixed position. Furthermore, the diameter of the grid insert preferably essentially corresponds to the inner diameter of the annular wall. The grid insert can preferably be introduced into the ring-shaped wall by means of a press fit, so that the transition between the wall and the grid insert is water-impermeable and thus tight.

The wall contained in the filter unit and the mounting element preferably have a channel, as described, which can act as an overflow and/or can be used to vent the container. The channel is preferably designed in such a way that pressure equalization is possible, but an exchange of substances or gases with the environment or the outside region of the intermediate storage dosing unit is prevented. In particular, the channel causes that, when the inlet valve is closed, no free surfaces of the fluid that is collected and that is present in the container is in direct contact with the outside region of the intermediate storage dosing unit, whereby evaporation is prevented. In this regard, a free flow or evaporation is preferably prevented (when the inlet valve is closed) via a hose connection to the atmosphere, which preferably leads downwards.

It is understood that a filter substrate preferentially retains solids from a fluid (gas or liquid stream). The filter substrate is preferably a flexible filter medium, for example a woven fabric, paper or fleece (fiber-oriented fleeces such as felts and random fiber fleeces such as spunbonded fleeces). The filter substrate is particularly preferably a flat fleece which can cover the grid insert over its entire extent and is also held by it. The great advantage of filtration with fleece is its flexibility. By simply replacing the filter fleece, the filter unit can be quickly converted for a new filtration task. Preferably, the filter fleece can also be glued to the grid insert, which advantageously does not produce any dead volume (for example, in contrast to clamping). Depending on the region of application (e.g. depending on the fluid used), various materials can be used for the filtration task according to the invention, for example synthetic fibers (made of polyester, polyphenylene sulphide, polytetrafluoroethylene etc.), ceramic fibers/sintered bodies, cellulose fibers, glass fibers or even metals and mixtures of the aforementioned fibers. These can be treated chemically or physically and have surface coatings.

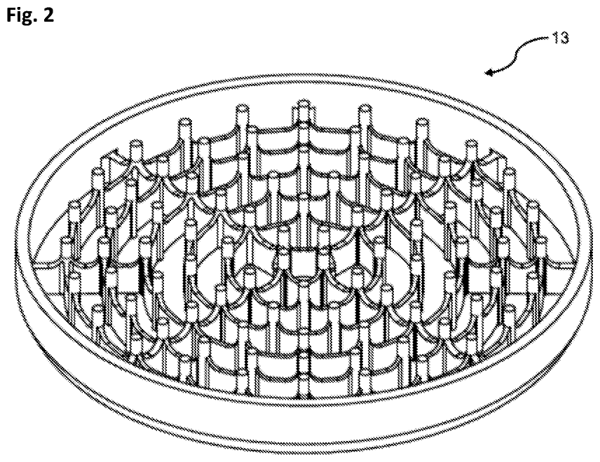

The grid insert is preferably designed for the filter fleece in such a way that as little water as possible is retained by adhesion. A dripping of adhering water is favored by a column structure, wherein the columns being rounded on an upper side, on which the fleece filter fabric is preferably supported (cf. also FIG. 2). At the same time, the grid insert or the columns have a certain height, which serves to ensure stability, while at the same time having a minimal surface compared to a conventional grid as a support.

In a further preferred embodiment, the filter support is a 3D-printed component. All elements of the filter support, namely the wall with the mounting element and the grid insert, are preferably manufactured individually. Because the filter support can be printed, there are significant advantages in its manufacture. In this way, individual filter supports can be produced in relation to the intermediate storage dosing unit, which supports are precisely matched to the container. The intermediate storage dosing unit can preferably differ in size and shape (depending on the intended use). Furthermore, the filter support can preferably also be matched to the filter substrate in terms of its structural configuration. In addition, the filter support advantageously does not have to be reworked and can be manufactured as a spare part at any time. Furthermore, a high degree of accuracy can be achieved by the method and, moreover, the method leads to a very rapid production in terms of time.

In a preferred embodiment, the printing time is preferably about 25 hours. The post-processing and the insertion of the fleece preferably require about 3 hours. In contrast, internal tortuous channels are advantageously possible compared to CNC machining. The filter support is particularly preferably a Low Force Stereo Lithography (LFS)-printed component. Low Force Stereolithography (LFS) technology is a preferred embodiment of SLA 3D printing and is well known to the skilled in the art. This preferred form of SLA printing uses a flexible tank and linear lighting, which significantly reduces the forces acting on the parts being produced and can result in improved surface quality and print accuracy. Lower compressive forces allow the use of touch-sensitive support structures that can be easily detached.

In further preferred variants, further preferred 3-D printing methods are also possible for the production of the filter support, for example FDM printing methods.

In a further preferred embodiment, the intermediate storage dosing unit has a housing which contains the container according to the invention and electronics for a data processing unit and/or a control unit. The region below the filter unit within the container is preferably vented freely to the outside through the channel. Furthermore, the container is preferably closed with a cover element, the cover element having on the one hand an opening for the inlet and on the other hand further openings and/or cutouts for sucking in air above the filter unit. The openings and/or cutouts for sucking in air preferably include a non-return valve, which has the function of allowing the sample water to flow out when the pressure in the container is negative (closed inlet valve).

If the container overflows, a separate connection can drain the water preferably below and above the filter unit. Both connections can be brought together via hoses to the drain, preferably at an outlet valve unit, and discharged. This ensures that no water can run into the open housing of the intermediate storage dosing unit, regardless of the operating status. There it would possibly cause condensation on the electronics.

In a further preferred embodiment, the invention relates to a system for taking samples of a fluid, preferably water, comprising
a. a sample acquisition unit configured to provide a fluid;
b. at least one sample vessel which is configured to contain and store a fluid;

wherein a fluid transfer is possible between the sample acquisition unit and the at least one sample vessel;

characterized in that

an intermediate storage dosing unit according to the type described in the previous embodiments is interposed between the sample, acquisition unit and the at least one sample vessel.

The proposed system can preferably be used for sampling all types of water, such as: rain, river, lake, spring, well, passage hole, snow, soil moisture, sap flow (plant water) and inline in processes, e.g. in drinking water production, waste water or industrial water and all other liquids including hydrocarbons and also gases. A person skilled in the art recognizes that the advantages, technical effects and preferred embodiments discussed in connection with the intermediate storage dosing unit according to the invention apply analogously to the system according to the invention for taking samples of a fluid, preferably water. Likewise, all advantages, technical effects and preferred embodiments which are described in the context of the system can be transferred to the intermediate storage dosing unit.

In particular, the system allows for filtering of a sample (while preserving the geo-chemical properties of the fluid) via the intermediate storage dosing unit, a controlled fluid transfer and/or a sample collected cumulatively over a period of time, whereby the quality of the result of the analysis of the samples to be taken is improved. Above all, the system also offers the possibility of providing a particularly compact sampling structure, which requires only a few system components and—once it has been set up—can be used for a large number of samples and analyzes without further changes. Due to the small number of components, the system enables a particularly compact design, which can be individually adapted to the sampling conditions.

The sample acquisition unit is preferably to be understood, for example, as a rain collection funnel, a pump, a suction cup, or a gravitational inflow or a lysimeter. Advantageously, a rain collection funnel, a suction cup, or a gravitational inflow does not require any energy for the provision of a fluid, whereas a pump enables an advantageous controlled continuous provision of a fluid.

It goes without saying that the sample vessel according to the invention is preferably an object which has a hollow space in its interior which in particular serves the purpose of separating its contents from its environment. The sample vessel can preferably be a flexible one and/or be a substantially rigid object formed of one material and/or has means which hermetically seal a sample from the atmosphere.

Within the meaning of the invention, a fluid transfer is preferably possible if at least two entities (for example sample acquisition unit, sample vessel or intermediate storage dosing unit) are in fluid communication with one another. A fluid transfer specifically means that a fluid can pass/flow from one entity to another entity via a conduit. Preferably, a conduit connection can be provided between a preferred sample vessel, a sample acquisition unit and/or an intermediate storage dosing unit. The intermediate storage dosing unit is preferably interposed between the sample acquisition unit and at least one sample vessel in the conduit connection, wherein it is also possible for a fluid to be routed from the sample acquisition unit to the sample vessel via the intermediate storage dosing unit.

In a further preferred embodiment, the system is characterized in that the system comprises a conduit system connected to the intermediate storage dosing unit, in particular to the riser as the second outlet of the intermediate storage dosing unit, and the at least one sample vessel can be connected to or separated from the conduit system, wherein a fluid transfer between the intermediate storage dosing unit and the at least one sample vessel is possible in the case of a sample vessel connected to the conduit system. This advantageously enables a cascadable modular structure of the system according to the invention, whereby sample vessels can be lined up in a row and, depending on requirements, can be connected or disconnected to or from the conduit system by means of individual control and suitable interfaces, thereby realizing a fluid transfer between the intermediate storage dosing unit and the respective sample vessel. Furthermore, any scaling of the number of samples and sample vessels is possible. At least one sample vessel can be connected to or disconnected from the conduit system, whereby the preferred system is not limited to a maximum number of sample vessels. For example —without being restricted to this —2 to several 100 sample vessels (there is no theoretical limit) can be individually connected to or disconnected from the conduit system. The system can therefore advantageously be expanded at any time in a particularly simplified form and allows the invention to be flexibly configured for the application.

The conduit system preferably serves to transport fluids (gases and liquids). The conduit system preferably includes pipes, pipe connections, hoses and/or associated fittings. In addition, pumping devices are preferably used to support the transport of the fluid,

In a further preferred embodiment, the system is characterized in that the system comprises a data processing unit and to the at least one sample vessel an identification number, a control unit and a valve are assigned, the control unit being in data communication with the data processing unit and being configured to open and/or close the valve;
wherein the data processing unit is configured to generate fill level-dependent and/or sample vessel-dependent control commands and to address the control unit using the identification number and to transmit the control commands to the control unit;
wherein the sample vessel is connected to the conduit system when the valve is open and the sample vessel is disconnected from the conduit system when the valve is closed.

This advantageously leads to a “smart” system which, in particular, has automated control intelligence, wherein automated changes to the control process can be made while a sample is being taken. The proposed system for solving the above problem is neither known from the prior art nor obvious to an average person skilled in the art. Rather, the system according to the invention is to be regarded as a departure from the prior art, in which, in particular, sampling takes place without pre-filtering a fluid and, moreover, manual monitoring, analysis, transmission and/or processing steps must be included. In contrast, the system according to the invention offers the possibility of carrying out a fully automatically executed method for taking discrete samples of a fluid, preferably water, wherein in particular the fluid is pre-filtered, but the geo-chemical properties of the fluid and/or of the sample are retained.

According to the invention, a data processing unit preferably includes means for generating, processing, storing, sending and receiving data. The data processing unit is preferably data-connected to one or more control units and to sensors included in the system (such as a fluid level sensor), whereby data can be transmitted bidirectionally between these system components. In a preferred embodiment, the data processing unit carries out algorithms and calculations by receiving input data from the control units or from sensors and, after the algorithms have been carried out, generating output data which comprise adapted control commands for the control unit. The advantage of such an arrangement is that the control units and sensors do not have to be equipped with components (or only with components of small capacity) for data processing (processor) and data storage, which advantageously achieves low energy consumption, preferably when autonomous field operation is desired. A further advantage is that the data processing unit can include a large number of recorded data from different sensors and control units for its analysis or implementation of the algorithms, so that a far-reaching analysis is made possible. The data processing unit can preferably be in the form of a server which is connected to the Internet and which other end devices can access. In this way, different responsible bodies or persons can advantageously be informed at any time about the taking of a sample. The system can preferably be controlled via software installed on the data processing unit, which can also be configured wirelessly from a distance using a terminal device via an app-based interface.

If the system includes a large number of sample vessels with associated control units, the control units are preferably connected to one another in an electronic bus system. This advantageously results in the data being transmitted between the data processing unit and the respective control units via a common transmission path. The design of the cabling between the control units connected to a bus system is preferably uniform. The number of data lines required is correspondingly significantly lower. Furthermore, the data lines are also shorter in length since they are preferably not wired individually to the data processing unit. The type, scope and direction of the data to be transmitted is also irrelevant as long as the bus system is not overloaded. The bus system preferably has a transmitting and receiving unit which has a wireless data connection to the data processing unit, with the transmitting and receiving unit of the bus system being able to forward the data from the data processing unit to the various control units via the data conduit of the bus system.

In terms of the invention, a control unit preferably has means for generating, processing, storing, sending and receiving data. The control unit is preferably in data communication with the data processing unit. Furthermore, the control unit preferably has means that can convert an electrical signal into mechanical movements and can thus actively intervene in a controlled process. According to the invention, the control unit is designed in such a way that it enables the behavior of the valve to be influenced in a targeted manner. In a preferred configuration, the control unit is able to control and regulate the valve. While controlling, the valve is influenced with the help of a manipulated variable—without the controlled variable having a retroactive effect on the manipulated variable. According to the invention, regulation is preferably a process in which the “ACTUAL value” of a variable is determined and matched to a “TARGET value” by adjustment. The “ACTUAL value” is preferably determined, for example, by sensors for determining a fill level within a sample vessel. Since the valve is regulated by the control unit, it is advantageously possible to react to changes in the fill level in the sample vessels within a short time and to adjust the valve accordingly by the control unit. In this regard, the control unit preferably has microchips, which are connected to the preferred bus system. The distributed control intelligence with microchips saves energy and a time-consuming assembly. The individual control units or microchips are preferably connected via a bus system in any topology. However, this can preferably also be implemented wirelessly using appropriate interfaces. This means that each individual valve does not have to be wired individually in order to open and/or close a valve.

An identification number is preferably assigned to each sample vessel and to the associated control unit. In this case, the identification number can preferably represent a unique alphanumeric addressing, by means of which each control unit included in the system can be reached. It goes without saying that, within the meaning of the invention, any number of sample vessels, each with associated individual valves and their own control unit, are included in the system. These can be connected in series, for example. The unique identification number (ID) is also preferably contained in a stored protocol and enables a unique sample assignment.

Within the meaning of the invention, sample vessels that have been disconnected are preferably individually closed off and, in particular, hermetically sealed, so that long-term preservation in the sample vessels is made possible.

For the purposes of the invention, level-dependent control commands are preferably commands that depend, for example, on a level in the intermediate storage dosing unit and/or on the individual sample vessels (without being limited to). For example, when the sample vessel is full, the control command can include the closing of the sample vessel with a valve. The fill level-dependent control commands can be obtained by automated analyzes of the data processing unit, which preferably receives information about the respective fill levels of all sample vessels and the intermediate storage dosing unit via various sensors included in the system.

Sample vessel-dependent control commands are to be understood, inter alia, as preferably commands that are dependent on a sample vessel, for example dependent on the volume of a sample vessel or dependent on a specific selection or addressing of a sample vessel (without being restricted thereto). The sample vessel-dependent control commands can be obtained through automated analyzes of the data processing unit, or by input from a user via an input interface (if, for example, a specific sample vessel is to be connected to the conduit system or the sample vessel is to be filled and is selected by a user).

In a further preferred embodiment, the system is characterized in that
the conduit system comprises an inline pump which is configured to produce a fluid flow between the intermediate storage dosing unit and a sample vessel connected to the conduit system;
the control unit is configured to control the valve via an actuator.

An actuator is preferably to be understood as a drive unit that converts an electrical signal (commands issued by the control unit) into mechanical movements or changes in physical variables and thus actively intervenes in the controlled process. The combination of actuator and control unit enables a system that can be carried out fully automatically, wherein the individual sample vessels can be filled in a controlled manner.

The system according to the invention is also preferably configured to carry out a flushing process in that all sample vessels in the conduit system are disconnected and the conduit system preferably has a further outlet at its conduit end. In this way, it can be prevented, among other things, that individual samples are mixed and correspondingly falsified. In a further preferred embodiment, the inline pump is designed as a peristaltic pump. The pump can preferably convey a fluid and/or a sample in two directions. After a sample vessel has been completely filled, the inline pump preferably runs in reverse, which means that any “overhanging air space” of the individual sample can be completely emptied. This serves, among other things, to ensure that only a fluid and no air-water mixture is pumped. In addition, the air contained in the sample and in the conduit up to the sample is advantageously skimmed off, so that no chemical processes can take place between the enclosed air and the sample.

In a further preferred embodiment, the system is characterized in that
the valve is designed as a ball valve, preferably as a three-way valve;
the intermediate storage dosing unit comprises a fluid level sensor which is configured to monitor the fill level of the fluid in the container, wherein the fluid level sensor is in data communication with the data processing unit and the latter provides a fill level-related parameter;
the data processing unit is configured to generate fill level-dependent control commands on the basis of the fill level-related parameter.

In a preferred embodiment, the data processing unit is configured to analyze the fill level-related parameters of the fluid level sensor and to subsequently generate fill level-dependent control commands. The analysis is therefore preferably to be regarded as a computer-implemented method step. Such an analysis can preferably be represented as a comparison between reference data or can also be carried out by an analysis using artificial intelligence algorithms.

The ball valve is preferably designed as a three-way valve with a T-passage in a T2 circuit. When not actuated, the T is preferably set to flow and the sample flows through the valve (the respective sample vessel is tightly closed; fluid transfer with the intermediate storage dosing unit is not possible). When actuated, the T moves preferentially to the respective sample vessel and deflects the sample flow into it until a corresponding sample volume is reached (a fluid transfer with the intermediate storage dosing unit is possible). The valve then returns to the non-actuated/flow position and seals the sample permanently and hermetically. The actuator preferably actuates the ball valve by 90° via a plug-in drive with fixed stops.

In a further preferred embodiment, the system is characterized in that the system comprises at least two sample vessels and the sample vessels within the conduit system can be filled one after the other. Filling more than one sample vessel enables a large number of different samples to be secured. Because the proposed system can be expanded with any number of sample vessels, there are no limits to the number of different samples. The preferred data processing unit can log the filling of all sample vessels, so that at least one point in time and one fluid can advantageously also be assigned to each sample vessel retrospectively in the case of a large number of samples. In a further preferred embodiment, the invention relates to a method for taking samples of a fluid, preferably water, characterized in that
a. a fluid is provided by a sampling unit of an intermediate storage dosing unit according to one or more of claims 1 to 3;
b. a fluid level sensor continuously detects a fill level of the fluid in the container of the intermediate storage dosing unit and provides a fill level-related parameter to a data processing unit;
c. the data processing unit generates sample vessel-dependent and fill level-dependent control commands;
d. the control commands are transmitted to a control unit assigned to a sample vessel;
e. the control unit opens a valve assigned to the sample vessel via an actuator,
f. a fluid transfer takes place between the intermediate storage dosing unit and the sample vessel, in that an inline pump generates a fluid flow;
g. the sample vessel receives and stores the fluid and seals it hermetically, wherein the inline pump preferably runs in reverse before the sample vessel is hermetically sealed in order to skim off the air contained in the sample vessel and in the conduit

The combination of the proposed steps leads to a surprising synergy effect, which leads to the advantageous properties and the associated overall success of the invention, wherein the individual features interact with one another. An important advantage of the method according to the invention is the need for extremely few method steps and system components, while an extremely robust and error-resistant infrastructure for taking samples of a fluid, preferably water, is nevertheless generated. Due to its few system components and method steps, the method can advantageously be implemented in a particularly simplified manner in already existing systems or devices by adding intermediate storage dosing unit and a data processing unit. The innovation of the method according to the invention also consists in the fact that a sample can be taken fully automatically, wherein the method is also extremely reliable.

### FIGURES

The invention will be explained in more detail below by means of the figures, without being limited to these.

### BRIEF DESCRIPTION OF THE FIGURES

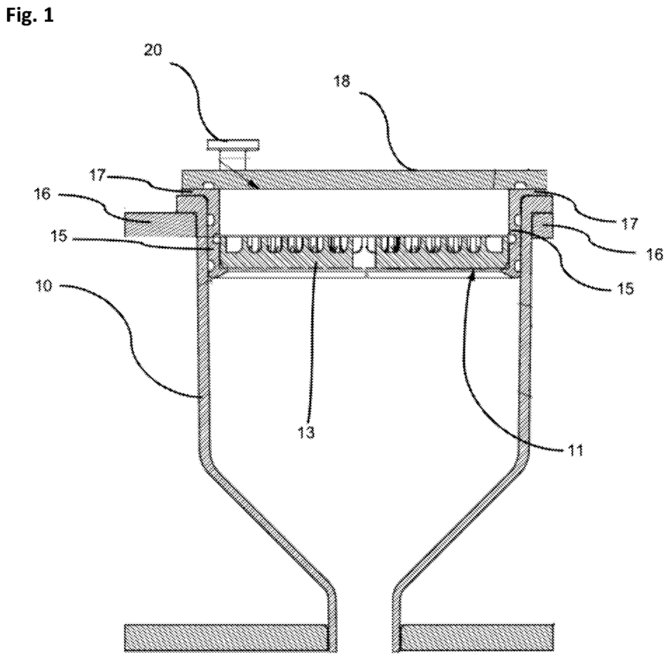

FIG. 1 shows a sectional view of a preferred container with a preferred filter unit for a preferred intermediate storage dosing unit

FIG. 2 shows a representation of a preferred grid insert

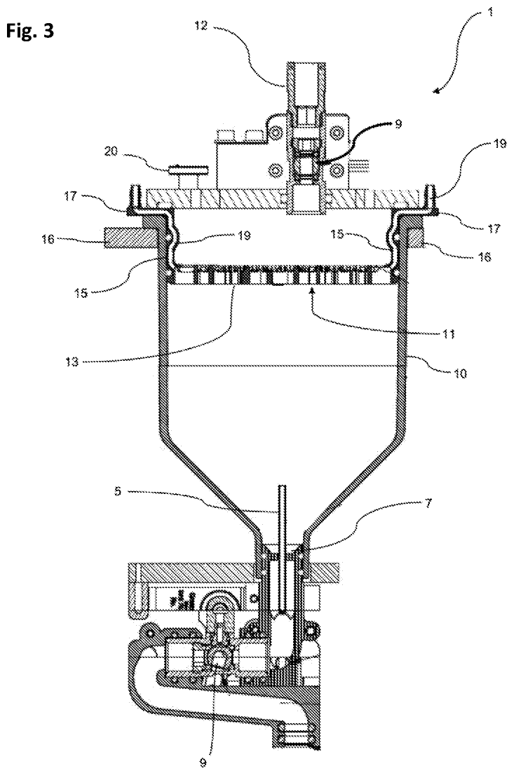

FIG. 3 shows a sectional view of a preferred intermediate storage dosing unit

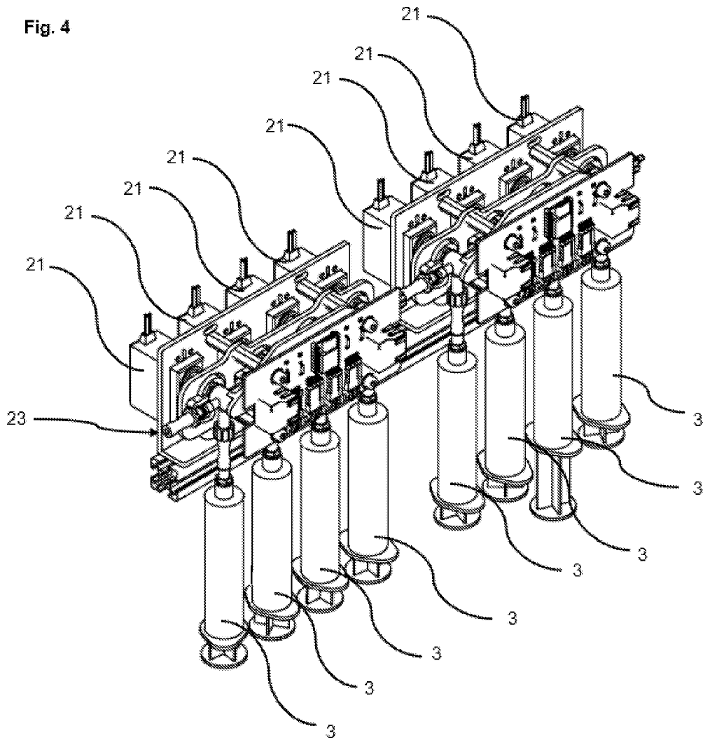

FIG. 4 shows a representation of a preferred conduit system with eight sample vessels that can be connected and disconnected

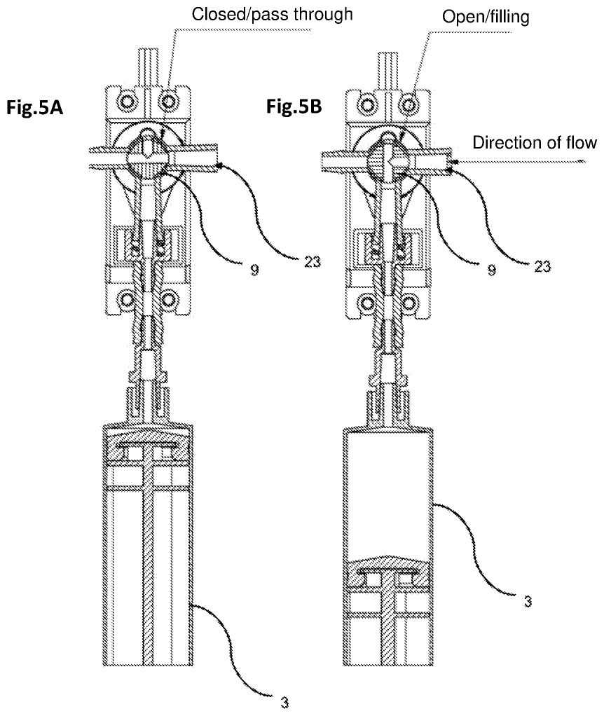

FIG. 5 shows a sectional view of a preferred sample vessel and the connection to a preferred conduit system

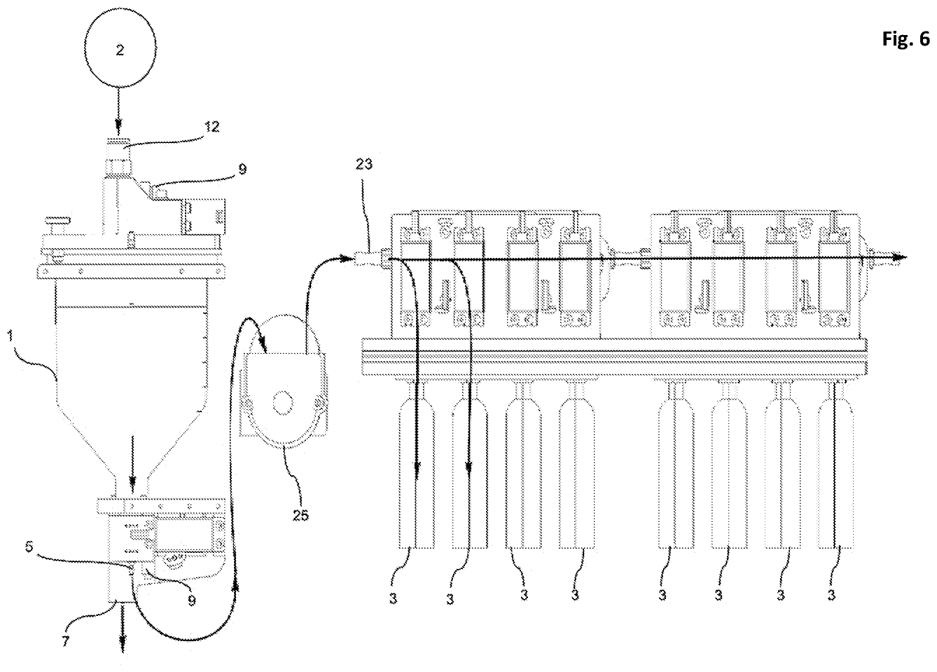

FIG. 6 shows a schematic representation of a preferred system

### DETAILED DESCRIPTION OF THE FIGURES

FIG. 1 shows a sectional view of a preferred container 10 with a preferred filter unit 11 for a preferred intermediate storage dosing unit 1. The container 10 is preferably to be divided into two portions, namely an upper cylindrical portion and a lower portion that tapers conically in the direction of an outlet. The upper cylindrical portion has an overhang which can be placed on a container holder 16. The filter unit 11 is preferably provided inside the container 10 in the upper cylindrical portion. The filter unit 11 preferably comprises a wall 15 with a mounting element 17, wherein the wall 15 is ring-shaped, namely it forms a closed ring, and has a shoulder at its upper edge, which is referred to as a mounting element 17. The ring-shaped wall 15 is placed inside the container 10 and placed on the upper edge of the container, in particular on the overhang of the container, via the mounting element 17. Within the annular wall 15, a grid insert 13 is preferably inserted. The wall preferably has a clamping element 15 in which the grid insert 13 can be clamped in a fixed position. A cover element 18 is preferably placed on the upper cylindrical portion of the container 10, wherein the mounting element 17 is positioned between the cover element 18 and the edge of the container 10. The cover element 18 preferably comprises two tall knurled screws 20, diagonally opposite one another when viewed from above, which can be screwed into the container holder 16, wherein it is possible for the overhang of the container edge and the mounting element 17 to be clamped in a non-positive manner between the holder 16 and the cover element 18 (Only one of the two can be seen in FIG. 1 due to the sectional view at the top left). In the wall 15 there are preferably grooves for two O-rings, which contribute to holding the filter unit 11 in a fixed position. The O-rings, as seals, along with a preferred third seal at the top under the cover element 18 are required for sealing to the outside. The filter unit 11 and the grid insert 13 can preferably be removed manually without the use of tools, for example for cleaning. The entire intermediate storage dosing unit 1, in particular the container 10, can also be removed without tools after loosening said two knurled screws 20 for cleaning or replacement. The ring-shaped wall 15 also preferably has an outside diameter which is essentially as large as the inside diameter of the container 10 in the upper cylindrical portion.

FIG. 2 shows a representation of a preferred grid insert 13. The grid insert 13 is preferably configured to be introduced into a wall 15 designed as a ring, wherein the diameter of the grid insert 13 essentially corresponds to the inside diameter of the annular wall 15. The grid insert 13 can preferably be introduced into the ring-shaped wall 15 by means of a press fit, so that the transition between the wall 15 and the grid insert 13 is water-impermeable and thus tight. The grid insert 13 is also configured to accommodate a filter substrate on grid elements. The filter substrate can comprise a fleece, for example.

The preferred grid insert 13 is intended on the one hand to create an optimal support (evenly distributed support points) and support for the very filigree and fine filter fleece (preferably 105 μm mesh size, more preferably 300 μm, in particular a maximum of 500 μm). On the other hand, the grid insert 13 should retain as little as possible sample fluid when wetted with the sample fluid. For this reason, the grid insert 13 preferably comprises small columns on which the fleece rests (filter fleece and grid insert 13 are preferably glued to one another on the outer circumference). This achieves the lowest possible retention when a film of fluid forms droplets which follow a trajectory, then coalesce and become a large droplet heavy enough to fall into the vessel. The grid webs between the drip columns are preferably narrow and kept as small as possible in terms of number and only have the task of holding the aforementioned columns. In a further step, the columns can comprise drip tips in a lower portion. All inner crossing points or inner edges of the grid webs are preferably rounded with small radii in order to minimize adhesions.

FIG. 3 shows a sectional view of a preferred intermediate storage dosing unit 1. In particular, the preferred intermediate storage dosing unit 1 comprises a container 10 with an inlet 12 and a two-way outlet. The container 10 tapers conically in the direction of the two-way outlet. The two-way outlet has a riser 5 as a first outlet and a drain 7 as a second outlet. The drain 7 of the two-way outlet and the inlet 12 can preferably be closed by a ball valve 9. In addition, the intermediate storage dosing unit 1 has a filter unit 11. The filter unit 11 preferably consists of a ring-shaped wall 15 with a mounting element 17, the ring-shaped wall 15 having an outer diameter which is essentially as large as the inner diameter of the container 10. The filter unit 11 is preferably sealed with the container 10 by two circumferential O Rings (made of EPDM or NBR). The mounting element 17 of the wall 15 is preferably placed on the upper edge of the container 10. The wall 15 designed as a ring also has a shape that allows a grid insert 13 to be accommodated and clamped inside the same. Preferably, in the wall 15 and in the mounting element 17 a channel 19 is introduced which is acting as an overflow and/or for venting the container 10. Furthermore, a filter substrate preferably rests on the grid insert 13, wherein the filter substrate preferably comprises a fleece. The channel 19 allows for pressure equalization, wherein no free surfaces of a collected fluid are in direct contact with the outside of the container 10. As a result, this arrangement counteracts evaporation. A free flow or evaporation is advantageously prevented via a hose connection leading downward to the atmosphere when the inlet valve 9 is closed. However, as long as the inlet valve 9 is open, a gas exchange of the container 10 with the atmosphere is possible.

FIG. 4 shows a preferred conduit system 23 with eight sample vessels 3 that can be connected and disconnected. Each sample vessel 3 is preferably assigned an identification number, a control unit 21 and a valve. Preferably, each control unit 21 is in data communication with a central data processing unit. The data processing unit is in particular configured to generate fill level-dependent and/or sample vessel-dependent control commands and to address by means of the identification number, a control unit 21 and to transmit the control commands to the selected control unit 21. The control unit 21, on the other hand, is set up to control the valve via an actuator, taking into account the control commands, and to open and/or close the valve assigned to a sample vessel 3.

In the present case, the sample vessels preferably consist of groups of four, which are arranged on mounting profiles with slot nuts so that they can be moved and positioned freely. A universal arrangement in all spatial directions and for all vessel sizes can thus be implemented. The concept is therefore also suitable for laboratory structures, measuring hut installations and equipment box installations. The drives of the three-way valves are preferably provided via servo drives with feedback of the valve position.

FIG. 5 illustrates a sectional view of a preferred sample vessel 3 and its connection to a preferred conduit system 23. The sample vessel 3 is preferably designed as a commercially available syringe which includes a moveable, sealed plunger that provides a variable, but nevertheless closed sample volume. The system preferably includes an inline pump which is configured to produce a fluid flow between the intermediate storage dosing unit 1 (not shown in FIG. 5) and a sample vessel 3 connected to the conduit system 23. The conduit system 23 preferably comprises the material FEP (tetrafluoroethylene-hexafluoropropylene copolymer), which has only an extremely low permeability to diffusion and thus brings about good long-term storage conditions for sample storage. The sample vessel 3 is preferably associated with a valve, which can be switched via a control unit 21 using an actuator in an open and/or closed position.

The embodiment illustrated in FIG. 5A shows a disconnected sample vessel 3, wherein the valve is a ball valve 9 (T-valve) and is in a closed position. Correspondingly, the fluid cannot be introduced into the sample vessel 3 and is passed through the ball valve 9 (T-valve) beyond the sample vessel 3. In the closed position of the valve 9, the sample vessel 3 is hermetically sealed.

In contrast, the embodiment illustrated in FIG. 5B shows a sample vessel 3 connected to the conduit system 23 in that a ball valve 9 (T-valve) is switched to an open position. The sample can be filled into the sample vessel 3 in this open position. The fluid is fed into the sample vessel 3 through the ball valve 9 (T-valve).

FIG. 6 shows a schematic representation of a preferred system for taking samples of a fluid, preferably water. The preferred system comprises in particular a sample acquisition unit 2 and eight sample vessels 3, wherein the sample acquisition unit 2 is configured to provide a fluid and the respective sample vessels 3 are configured to receive and store a fluid. A fluid transfer is preferably possible between the sample acquisition unit 2 and the respective sample vessels 3. In addition, an intermediate storage dosing unit 1 is connected between the sample acquisition unit 2 and the sample, vessels 3.

The sample acquisition unit 2 can be designed, for example, as a rain collection funnel, a pump, a suction cup, or a gravitational inflow or a lysimeter. In the case of heavy rain events, for example, larger volumes can be collected first, from which one or more small samples can then be taken.

In this case, a sample is first transferred via the sample acquisition unit 2 into the intermediate storage dosing unit 1. The intermediate storage dosing unit 1 preferably comprises an inlet 12 which can preferably be closed by a motor-controlled ball valve 9. Furthermore, the intermediate storage dosing unit 1 has a container 10 and a filter unit 11 (not shown in FIG. 6) in order to be able to filter and collect the sample provided. Furthermore, a two-way outlet is designed in the intermediate storage dosing unit 1, namely a riser 5 as a first outlet and a drain 7 as a second outlet. The riser 5 is used to take samples from a water column in order to prevent the system from being contaminated by suspended solids and sediment. The drain 7, on the other hand, serves to remove excess sample fluid by gravity after a filling process. The drain 7 is preferably also closed by a motor-driven ball valve 9.

The sample is then conveyed into a preferred conduit system 23 via the riser 5, preferably with a peristaltic pump 25. Before each filling process, the entire conduit system 23 is flushed with the sample in order to prevent a previous sample from being carried over. A valve is preferably assigned to the sample vessels 3, which valve in each case can be switched to an open and/or dosed position via control units 21 by means of an actuator. As a result, the sample vessels 3 can be individually connected to the conduit system 23 so that they can be filled with the sample.

In the course of a flushing process, all sample vessels 3 in the conduit system 23 are disconnected, wherein the conduit system 23 preferably has a further outlet at its conduit end. The sample vessels 3 are preferably hermetically sealed and accordingly ensure long-term preservation of the sample without exchange with the environment. Before the sample vessel 3 is hermetically sealed, the peristaltic pump 25 preferably runs in reverse in order to skim off the air contained in the sample vessel 3 and in the conduit

### LIST OF REFERENCE NUMERALS

1 Intermediate storage dosing unit
2 sample acquisition unit
3 sample vessel
5 riser
7 drain
9 ball valve
10 container
11 filter unit
12 inlet
13 grid insert
15 wall
16 container holder
17 mounting element
18 cover element
19 channel (venting/overflow)
20 knurled screw
21 control unit
23 conduit system
25 peristaltic pump

1. An intermediate storage dosing unit (1) for taking samples of a fluid, comprising a container (10) with an inlet (12) and a two-way outlet, wherein the two-way outlet comprises
a riser (5) as a first outlet and
a drain (7) as a second outlet.

2. The intermediate storage dosing unit (1) of claim 1
characterized in that
the drain (7) of the two-way outlet and/or the inlet (12) can be closed by a respective valve.

3. The intermediate storage dosing unit (1) of claim 1
characterized in that
the intermediate storage dosing unit (1) has a filter unit (11) which comprises a filter support and a filter substrate;
wherein the filter support is designed as a grid insert (13) with a wall (15) and a mounting element (17);
wherein a channel (19) which acts as an overflow and/or for venting the container is arranged in the wall (15) and in the mounting element (17),
wherein the filter substrate rests on the grid insert (13).

4. A system for taking samples of a fluid comprising
a sample acquisition unit (2) configured to provide a fluid;
at least one sample vessel (3), which is configured to contain and store a fluid;
wherein a fluid transfer is possible between the sample acquisition unit (2) and the at least one sample vessel (3);
characterized in that
an intermediate storage dosing unit (1) of claim 1 is interposed between the sample acquisition unit (2) and the at least one sample vessel (3).

5. The system of claim 4
characterized in that
the system comprises a conduit system (23) connected to the intermediate storage dosing unit (1), in particular to the riser (5) as a second outlet of the intermediate storage dosing unit (1), and the at least one sample vessel (3) can be connected to or disconnected from the conduit system (23), wherein when a sample vessel (3) is connected to the conduit system (23) a fluid transfer between the intermediate storage dosing unit (1) and the at least one sample vessel (3) is possible.

6. The system of claim 4
characterized in that
the system comprises a data processing unit and an identification number, a control unit (21) and a valve are assigned to the at least one sample vessel (3), wherein the control unit (21) is in data communication with the data processing unit and is configured to open and/or close the valve;
wherein the data processing unit is configured to generate fill level-dependent and/or sample vessel-dependent control commands and to address, by means of the identification number, the control unit (21) and to transmit the control commands to the control unit (21);
wherein the sample vessel (3) is connected to the conduit system (23) when the valve is open and the sample vessel (3) is disconnected from the conduit system (23) when the valve is closed.

7. The system of claim 6
characterized in that
the conduit system (23) comprises an inline pump which is configured to produce a fluid flow between the intermediate storage dosing unit (1) and a sample vessel (3) connected to the conduit system;
the control unit (21) is configured to control the valve via an actuator.

8. The system of claim 6
characterized in that
the valve is designed as a ball valve;
the intermediate storage dosing unit (1) comprises a fluid level sensor which is configured to monitor the fill level of the fluid in the container (10), wherein the fluid level sensor is in data communication with the data processing unit and provides a fill level-related parameter to the latter;
the data processing unit is configured to generate fill level-dependent control commands on the basis of the fill level-related parameter.

9. The system of claim 5
characterized in that
the system comprises at least two sample vessels (3) and the sample vessels (3) within the conduit system (23) can be filled one after the other.

10. A method for taking samples of a fluid
characterized in that
a fluid is provided by a sample acquisition unit to an intermediate storage dosing unit (1) of claim 1;
a fluid level sensor continuously detects a fill level of the fluid in the container (10) of the intermediate storage dosing unit (1) and provides a fill level-related parameter to a data processing unit;
the data processing unit generates sample vessel-dependent and fill level-dependent control commands;
the control commands are transmitted to a control unit (21) assigned to a sample vessel (3);
the control unit (21) opens a valve assigned to the sample vessel (3) via an actuator,
a fluid transfer takes place between the intermediate storage dosing unit (1) and the sample vessel (3), in that an inline pump generates a fluid flow;
the sample vessel (3) receives and stores the fluid and seals it hermetically, wherein the inline pump preferably runs in reverse before the sample vessel is hermetically sealed in order to draw off the air contained in the sample vessel and in the conduit.

11. The intermediate storage dosing unit (1) of claim 1
wherein the respective valve in at least one instance is a ball valve (9).

12. The intermediate storage dosing unit (1) of claim 3
wherein the filter substrate comprises a fleece.

13. The system of claim 4 wherein the fluid is water.

14. The system of claim 5
characterized in that
the system comprises a data processing unit and an identification number, a control unit (21) and a valve are assigned to the at least one sample vessel (3), wherein the control unit (21) is in data communication with the data processing unit and is configured to open and/or close the valve;
wherein the data processing unit is configured to generate fill level-dependent and/or sample vessel-dependent control commands and to address, by means of the identification number, the control unit (21) and to transmit the control commands to the control unit (21);
wherein the sample vessel (3) is connected to the conduit system (23) when the valve is open and the sample vessel (3) is disconnected from the conduit system (23) when the valve is closed.

15. The system of claim 6
wherein the valve is a three-way valve.
